(19) United States
(12) Patent Application Publication
(10) Pub. No.: US 2017/0025231 A1
(43) Pub. Date: Jan. 26, 2017

(54) ELECTROLYTE SOLUTION, AND ELECTROCHEMICAL DEVICE

(71) Applicant: DAIKIN INDUSTRIES, LTD., Osaka-shi, Osaka (JP)

(72) Inventor: Kenzou Takahashi, Settsu-shi, Osaka (JP)

(73) Assignee: DAIKIN INDUSTRIES, LTD., Osaka-shi, Osaka (JP)

(21) Appl. No.: 15/101,017

(22) PCT Filed: Dec. 11, 2014
(86) PCT No.: PCT/JP2014/082813

§ 371 Date: Jun. 2, 2016

(30) Foreign Application Priority Data
Dec. 12, 2013 (JP) 2013-257281

(51) Int. Cl. H01G 11/62; H01G 11/22; H01G 11/60

(52) U.S. Cl. CPC H01G 11/62; H01G 11/60; H01G 11/22

(57) ABSTRACT

The present invention aims to provide an electrolyte solution which has a low initial resistance, the resistance of which is less likely to increase even after long-term use, and which has high capacity retention. The present invention relates to: (i) an electrolyte solution including a mononitrile compound and a spirobipyrrolidinium salt, and being free from a non-fluorinated sulfolane compound, the spirobipyrrolidinium salt being present at a concentration of not less than 0.70 mol/L but less than 1.00 mol/L; and (ii) an electrolyte solution including a mononitrile compound, a non-fluorinated sulfolane compound, and a spirobipyrrolidinium salt, the spirobipyrrolidinium salt being present at a concentration of not less than 0.70 mol/L and not more than 1.30 mol/L.

### TECHNICAL FIELD

The present invention relates to electrolyte solutions and electrochemical devices including the electrolyte solutions.

### BACKGROUND ART

Electrolyte solutions often used for electrochemical devices, such as electric double-layer capacitors, include those prepared by dissolving a quaternary ammonium salt in an organic solvent, such as a cyclic carbonate (e.g., propylene carbonate) or a nitrile compound (for example, see Patent Literature 1).

In order to improve the properties of electrochemical devices, for example, for the purpose of suppressing a decrease in the withstand voltage or capacity of electrochemical devices, various methods are proposed, such as a method of decreasing the amount of specific impurities in such electrolyte solutions (for example, see Patent Literature documents 2 and 3).

Further, Patent Literature 4 discloses an electrolyte solution that is to be used for electric double-layer capacitors capable of working even at very low temperatures, and that contains a solvent containing acetonitrile and triethyl methyl ammonium tetrafluoroborate or spirobipyridinium tetrafluoroborate, which is a quaternary ammonium salt.

### CITATION LIST

### Patent Literature

Patent Literature 1: JP 2000-124077 A

Patent Literature 2: JP 2004-186246 A

Patent Literature 3: JP 2000-311839 A

Patent Literature 4: US 2011/0170237

### SUMMARY OF INVENTION

### Technical Problem

Electrochemical devices such as electric double-layer capacitors have more attracted the attention, and the field of the art has desired techniques of maintaining the properties of such electrochemical devices at higher levels.

The present invention is devised in consideration of the above situation, and aims to provide an electrolyte solution which has a low initial resistance, the resistance of which is less likely to increase even after long-term use, and which has high capacity retention.

### Solution to Problem

The inventor found that, in an electrolyte solution including a nitrile compound and a quaternary ammonium salt and being free from a non-fluorinated sulfolane compound, use of a mononitrile compound as the nitrile compound, use of a spirobipyrrolidinium salt as the quaternary ammonium salt, and adjustment of the concentration of the spirobipyrrolidinium salt within the range of not less than 0.70 mol/L but less than 1.00 mol/L based on the whole electrolyte solution enables production of an electrochemical device which has a low initial resistance, an increase in the resistance of which is sufficiently suppressed, and which has a sufficiently increased capacitance retention ratio. Thereby, the inventor arrived at the present invention.

The inventor also found that, in an electrolyte solution containing a nitrile compound and a quaternary ammonium salt, use of a mononitrile compound as the nitrile compound, use of a spirobipyrrolidinium salt as the quaternary ammonium salt, addition of a non-fluorinated sulfolane compound, and adjustment of the concentration of the spirobipyrrolidinium salt within the range of not less than 0.70 mol/L and not more than 1.30 mol/L based on the whole electrolyte solution enables production of an electrochemical device which has a low initial resistance, an increase in the resistance of which is sufficiently suppressed, and which has a sufficiently increased capacitance retention ratio. Thereby, the inventor arrived at the present invention.

Specifically, the present invention relates to an electrolyte solution (hereinafter, also referred to as a “first electrolyte solution of the present invention”) including a mononitrile compound and a spirobipyrrolidinium salt, and being free from a non-fluorinated sulfolane compound, the spirobipyrrolidinium salt being present at a concentration of not less than 0.70 mol/L but less than 1.00 mol/L.

The present invention also relates to an electrolyte solution (hereinafter, also referred to as a “second electrolyte solution of the present invention”) including: a mononitrile compound; a non-fluorinated sulfolane. compound; and a spirobipyrrolidinium salt, the spirobipyrrolidinium salt being present at a concentration of not less than 0.70 mol/L and not more than 1.30 mol/L.

In the first and second electrolyte solutions of the present invention, the spirobipyrrolidinium salt is preferably spirobipyrrolidinium tetrafluoroborate.

In the first and second electrolyte solutions of the present invention, the mononitrile compound is preferably acetonitrile.

The first and second electrolyte solutions of the present invention each preferably further include 0.05 to 5.0 mass % of a dinitrile compound.

The first and second electrolyte solutions of the present invention each preferably further include 0.05 to 5.0 mass % of a fluorine-containing acyclic sulfone or a fluorine-containing acyclic sulfonic ester.

The first and second electrolyte solutions of the present invention are preferably to be used for electrochemical devices.

The first and second electrolyte solutions of the present invention are preferably to be used for electric double-layer capacitors.

The present invention also relates to an electrochemical device including: the first or second electrolyte solution; a positive electrode; and a negative electrode.

The electrochemical device of the present invention is preferably an electric double-layer capacitor.

### Advantageous Effects of Invention

The present invention can provide an electrolyte solution and an electrochemical device which have a low initial resistance, the resistances of which are less likely to increase, and which achieve a high capacitance retention ratio.

### DESCRIPTION OF EMBODIMENTS

The first and second electrolyte solutions of the present invention each include a mononitrile compound and a spirobipyrrolidinium salt. The second electrolyte solution of the present invention further includes a non-fluorinated sulfolane compound.

The concentration of the spirobipyrrolidinium salt in the first electrolyte solution of the present invention is not less than 0.70 mol/L but less than 1.00 mol/L. The concentration thereof is preferably not less than 0.75 mol/L, more preferably not less than 0.80 mol/L, whereas the concentration thereof is preferably not more than 0.95 mol/L, more preferably not more than 0.90 mol/L.

The concentration of the spirobipyrrolidinium salt in the second electrolyte solution of the present invention is not less than 0.70 mol/L and not more than 1.30 mol/L. The concentration thereof is preferably not less than 0.75 mol/L, more preferably not less than 0.80 mol/L.

The concentration thereof is also preferably not more than 1.25 mol/L, more preferably not more than 1.20 mol/L, still more preferably less than 1.00 mol/L, particularly preferably not more than 0.95 mol/L, most preferably not more than 0.90 mol/L.

The concentration of the salt is advantageously as high as possible in order to provide an electrochemical device having a lower initial resistance and a higher capacity.

The following will describe the components to be contained in the first and second electrolyte solutions of the present invention in detail.

Examples of the mononitrile compound include mononitrile compounds represented by the following formula (I-A):

R¹—CN (I-A)

wherein R¹ is a C1-C10 alkyl group.

In the formula (I-A), R¹ is a C1-C10 alkyl group.

Examples of the alkyl group include C1-C10 alkyl groups such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, and a decyl group. For a low resistance, preferred among these is a methyl group or an ethyl group.

In other words, the mononitrile compound is preferably at least one selected from the group consisting of acetonitrile (CH₃—CN) and propionitrile (CH₃—CH₂—CN) so as to achieve a low resistance. The nitrile compound is more preferably acetonitrile.

The amount of the mononitrile compound in the first electrolyte solution of the present invention is preferably 50 to 100 vol %, more preferably 60 to 100 vol %, still more preferably 70 to 100 vol %, in the electrolyte solution.

The amount of the mononitrile compound in the second electrolyte solution of the present invention is preferably 50 to 99 vol %, more preferably 60 to 99 vol %, still more preferably 70 to 99 vol %.

The first and second electrolyte solutions of the present invention each preferably further include a dinitrile compound.

The dinitrile compound is preferably a compound represented by the formula (I-B):

NC—R²—CN (I-B)

wherein R² is a C1-C8 alkylene group which may optionally have a fluorine atom.

In the dinitrile compound represented by the formula (I-B), R² is a C1-C8 alkylene group which may optionally have a fluorine atom. The alkylene group preferably has a carbon number of 1 to 3.

R² is preferably a C1-C8 alkylene group or a C1-C7 fluoroalkylene group. The fluoroalkylene group is a group obtained by replacing part or all of the hydrogen atoms in an alkylene group by fluorine atoms.

R² is more preferably a C1-C7 alkylene group or a C1-C5 fluoroalkylene group, still more preferably a C1-C3 alkylene group.

In order to maintain a high output, R² is specifically preferably —CH₂—CH₂—, —CH₂—CH₂—CH₂—, or —CH₂—CH₂—CH₂—CH₂—.

In other words, the dinitrile compound is preferably at least one selected from the group consisting of succinonitrile (NC—CH₂—CH₂—CN), glutaronitrile (NC—CH₂—CH₂—CH₂—CN), and adiponitrile (NC—CH₂—CH₂—CH₂—CH₂—CN) so as to maintain a high output.

The concentration of the dinitrile compound is preferably 0.05 to 5.0 mass % in the electrolyte solution. The concentration thereof is more preferably not less than 0.1 mass %, still more preferably not less than 0.2 mass %, whereas the concentration thereof is more preferably not more than 4.0 mass %, still more preferably not more than 3.0 mass %.

The electrolyte solutions of the present invention each may further include a trinitrile compound.

The trinitrile compound is preferably a compound represented by the formula (I-C):

NC—R³—CX¹(CN)—R⁴—CN (I-C)

wherein X¹ is a hydrogen atom or a fluorine atom; R³ and R⁴ may be the same as or different from each other, and are each a C1-C5 alkylene group which may optionally have a fluorine atom.

In the formula (I-C) for the trinitrile compound, X¹ is a hydrogen atom or a fluorine atom.

R³ and R⁴ may be the same as or different from each other, and are each a C1-C5 alkylene group which may optionally have a fluorine atom. The alkylene group preferably has a carbon number of 1 to 3.

R³ and R⁴ are each preferably a C1-C5 alkylene group or a C1-C4 fluoroalkylene group. The fluoroalkylene group is a group obtained by replacing part or all of the hydrogen atoms in an alkylene group by fluorine atoms.

R³ and R⁴ are each more preferably a C1-C3 alkylene group.

Specifically, in order to maintain a high output, R³ and R⁴ are each still more preferably a C2 alkylene group.

The trinitrile compound is more preferably 4-cyanopentanedinitrile.

The concentration of the nitrile compound(s) other than the mononitrile compound is preferably 0.05 to 5.0 mass % in the electrolyte solution. With the concentration thereof within the above range, the capacitance can be maintained at a higher level.

The concentration thereof in the electrolyte solution is more preferably not less than 0.1 mass %, still more preferably not less than 0.2 mass %, whereas the concentration thereof is more preferably not more than 4.0 mass %, still more preferably not more than 3.0 mass %.

The first and second electrolyte solutions of the present invention each include a spirobipyrrolidiniumn salt as a quaternary ammonium salt.

Preferred examples of the spirobipyrrolidinium salt include compounds represented by the following formula (II):

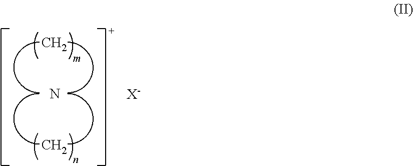

wherein m and n may be the same as or different from each other, and are each an integer of 3 to 7; and X⁻ is an anion.

In the formula (II), m and n may be the same as or different from each other, and are each an integer of 3 to 7. For good solubility of the salt, each of them is more preferably an integer of 4 or 5.

In the formula (II), X⁻ is an anion. The anion X⁻ may be either an inorganic anion or an organic anion. Examples of the inorganic anion include AlCl₄⁻, BF₄⁻, PF₆⁻, AsF₆⁻, TaF₆⁻, I⁻, and SbF₆⁻. Examples of the organic anion include CF₃COO⁻, CF₃SO₃⁻, (CF₃SO₂)₂N⁻, and (C₂F₅SO₂)₂N⁻. For good solubility of the salt, BF₄⁻ or PF₆⁻ is preferred, and BF₄⁻ is particularly preferred. In other words, the spirobipyrrolidinium salt is particularly preferably spirobipyrrolidinium tetrafluoroborate (SBPBF₄).

For good solubility of the salt, the spirobipyrrolidinium salt is specifically preferably selected from the below:

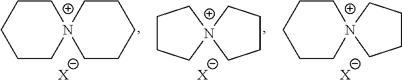

wherein X⁻ is BF₄⁻ or PF₆⁻, more preferably BF₄⁻.

These spirobipyrrolidinium salts are excellent in solubility, oxidation resistance, and ion conductivity.

The first electrolyte solution of the present invention may further include a fluorosulfolane compound.

The second electrolyte solution of the present invention includes a non-fluorinated sulfolane compound.

Examples of the non-fluorinated sulfolane compound include, in addition to sulfolane, non-fluorosulfolane derivatives represented by the following formula:

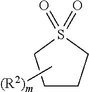

wherein R² is a C1-C4 alkyl group; and m is 1 or 2).

Preferred among these are the following sulfolane and sulfolane derivatives.

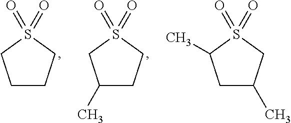

The first and second electrolyte solutions of the present invention each may further include a fluorosulfolane compound. Examples of the fluorosulfolane compound include fluorosulfolane compounds disclosed in JP 2003-132944 A, and those represented by the following formulas:

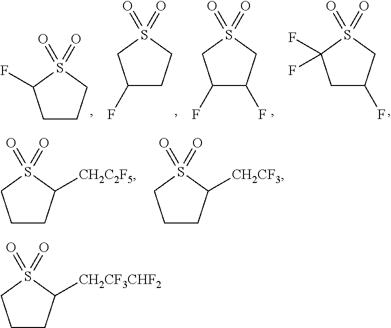

are preferred.

Preferred among these is sulfolane, 3-methylsulfolane, or 2,4-dimethylsulfolane, more preferred is sulfolane or 3-methyl sulfolane, and still more preferred is sulfolane.

In the second electrolyte solution of the present invention, the concentration of the non-fluorinated sulfolane compound in the electrolyte solution is preferably less than 50 vol %, more preferably less than 40 vol %, still more preferably less than 30 vol %, particularly preferably less than 20 vol %. The concentration thereof is also preferably not less than 1 vol % in the electrolyte solution. The sulfolane compound at a concentration within the above range can lead to improved long-term reliability.

In the second electrolyte solution of the present invention, the volume ratio between the mononitrile compound and the non-fluorinated sulfolane compound is preferably 50/50 to 99/1, more preferably 60/40 to 99/1, still more preferably 70/30 to 99/1.

In order to achieve a high capacitance retention ratio and to reduce the resistance increasing rate, the first and second electrolyte solutions of the present invention each preferably further include a fluorine-containing acyclic sulfone or a fluorine-containing acyclic sulfonic ester.

The fluorine-containing acyclic sulfone or the fluorine-containing acyclic sulfonic ester is preferably a compound represented by the formula (1):

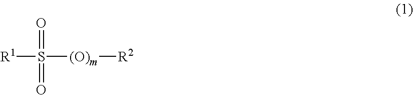

wherein m is 0 or 1; and R¹ and R² may be the same as or different from each other, and are each a C1-C7 alkyl group or a fluoroalkyl group, at least one of R¹ and R² is a fluoroalkyl group.

In the formula (1), the case where m is 1 means that the sulfur atom and R² are linked via an oxygen atom, and the case where m is 0 means that the sulfur atom and R² are directly linked.

R¹ and R² are each preferably a C1-C6 linear or branched alkyl group or a C1-C4 linear or branched fluoroalkyl group, and more preferably —CH₃, —C₂H₅, —C₃H₇, —C₄H₉, —C₅H₁₁, —C₆H₁₃, —CF₃, —C₂F₅, —CH₂CF₃, —CF₂CF₂H, —CH₂CF₂CF₃, —CH₂CF₂CF₂H, —CH₂CF₂CFH₂, —CF₂CH₂CF₃, —CF₂CHFCF₃, —CF₂CF₂CF₃, —CF₂CF₂CF₂H, —CH₂CF₂CF₃, —CH₂CF₂CF₂H, —CH₂CF₂CFH₂, —CH₂CF₂CH₃, —CH₂CFHCF₂H, —CH₂CFHCFH₂, or —CH₂CFHCH₃. They are each still more preferably —CH₃, —C₂H₅, —C₄H₉, —CH₂CF₃, —CF₂CHFCF₃, —CH₂CF₂CF₃, or —CH₂CF₂CF₂H.

Preferred among the compounds represented by the formula (1) are compounds represented by the formula (1′):

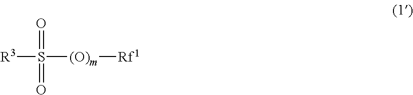

wherein m is 0 or 1; R³ is a C1-C7 alkyl group, and Rf¹ is a C1-C7 fluoroalkyl group.

Preferred configurations for R³ in the formula (1′) are the same as the preferred configurations in the formula (1) in which R¹ and R² are each a C1-C7 alkyl group. Preferred configurations for Rf¹ are also the same as the preferred configurations in the formula (1) in which R¹ and R² are each a C1-C7 fluoroalkyl group.

Specifically preferred examples of the compound represented by the formula (1) include HCF₂CF₂CH₂OSO₂CH₃, HCF₂CF₂CH₂OSO₂CH₂CH₃, CF₃CH₂OSO₂CH₃, CF₃CH₂OSO₂CH₂CH₃, CF₃CF₂CH₂OSO₂CH₃, and CF₃CF₂CH₂OSO₂CH₂CH₃.

Those represented by the following formulas:

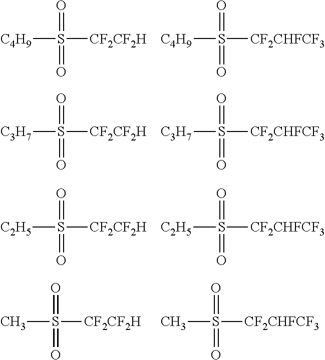

may also be specifically mentioned as the compounds represented by the formula (1). These compounds may be used alone or in combination of two or more.

The concentration of the fluorine-containing acyclic sulfone or the fluorine-containing acyclic sulfonic ester is preferably 0.05 to 5.0 mass %. The concentration thereof is more preferably not more than 4.0 mass %, still more preferably not more than 3.0 mass %. The concentration thereof is also more preferably not less than 0.1 mass %, still more preferably not less than 0.2 mass %.

The first and second electrolyte solutions of the present invention each may further include a fluoroether.

Examples of the fluoroether include an acyclic fluoroether (Ia) and a cyclic fluoroether (Ib).

Examples of the acyclic fluoroether (Ia) include compounds disclosed in JP H08-37024 A, JP H09-97627 A, JP H11-26015 A, JP 2000-294281 A, JP 2001-52737 A, and JP H11-307123 A.

Preferred among these compounds as the acyclic fluoroether (Ia) are acyclic fluoroethers represented by the following formula (Ia-1):

Rf¹—O—Rf² (Ia-1)

wherein Rf¹ is a C1-C10 fluoroalkyl group; and Rf² is a C1-C4 alkyl group which may optionally have a fluorine atom.

In the formula (Ia-1), Rf² is preferably a fluoroalkyl group because such a compound has particularly better oxidation resistance and compatibility with an electrolyte salt, a higher decomposition voltage, and a lower freezing point, so that the compound can better maintain the low-temperature characteristics, in comparison with the case where Rf² is a non-fluoroalkyl group.

Examples of the group for Rf¹ include C1-C10 fluoroalkyl groups such as HCF₂CF₂CH₂—, HCF₂CF₂CF₂CH₂—, HCF₂CF₂CF₂CF₂CH₂—, C₂F₅CH₂—, CF₃CFHCF₂CH₂—, HCF₂CF(CF₃) CH₂—, C₂F₅CH₂CH₂—, and CF₃CH₂CH₂—. Preferred among these are C3-C6 fluoroalkyl groups.

Examples of the group for Rf² include C1-C4 non-fluoroalkyl groups, —CF₂CF₂H, —CF₂CFHCF₃, —CF₂CF₂CF₂H, —CH₂CH₂CF₃, —CH₂CFHCF₃, and —CH₂CH₂C₂F₅. Preferred among these are C2-C4 fluoroalkyl groups.

For good ion conductivity, particularly preferably, Rf¹ is a C3-C4 fluoroalkyl group and Rf² is a C2-C3 fluoroalkyl group.

Specifically, for example, the acyclic fluoroether (Ia) may include one or two or more of HCF₂CF₂CH₂OCF₂CF₂H, CF₃CF₂CH₂OCF₂CF₂H, HCF₂CF₂CH₂OCF₂CFHCF₃, CF₃CF₂CH₂OCF₂CFHCF₃, HCF₂CF₂CH₂OCH₂CFHCF₃, CF₃CF₂CH₂OCH₂CFHCF₃, and the like. In order to maintain the high decomposition voltage and the low-temperature characteristics, the acyclic fluoroether (Ia) is particularly preferably HCF₂CF₂CH₂OCF₂CF₂H, HCF₂CF₂CH₂OCF₂CFHCF₃, CF₃CF₂CH₂OCF₂CFHCF₃, or CF₃CF₂CH₂OCF₂CF₂H.

Those represented by the following formulas:

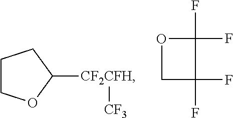

may be mentioned as the cyclic fluoroether (Ib).

The volume ratio between the fluoroether and the mononitrile compound is preferably 90/10 to 1/99, more preferably 40/60 to 1/99, still more preferably 30/70 to 1/99. With the volume ratio within this range, the withstand voltage can be maintained and the effect of reducing the internal resistance can be improved.

The first and second electrolyte solutions of the present invention each may further include any other solvents such as a cyclic carbonate (Ic) and an acyclic carbonate (Id), if necessary.

The cyclic carbonate (Ic) may be either a cyclic non-fluorocarbonate or a cyclic fluorocarbonate.

Examples of the cyclic non-fluorocarbonate include ethylene carbonate (EC), propylene carbonate (PC), and vinylene carbonate. For a good effect of reducing the internal resistance and maintenance of the low-temperature characteristics, propylene carbonate (PC) is preferred.

Examples of the cyclic fluorocarbonate include mono-, di-, tri-, or tetra-fluoroethylene carbonate and trifluoromethyl ethylene carbonate. In order to improve the withstand voltage of the electrochemical device, trifluoromethyl ethylene carbonate is preferred.

The acyclic carbonate (Id) may be either an acyclic non-fluorocarbonate or an acyclic fluorocarbonate.

Examples of the acyclic non-fluorocarbonate include dimethyl carbonate (DMC), diethyl carbonate (DEC), ethyl methyl carbonate (EMC), methyl isopropyl carbonate (MIPC), ethyl isopropyl carbonate (EIPC), and 2,2,2-trifluoroethyl methyl carbonate (TFEMC). For a good effect of reducing the internal resistance and maintenance of the low-temperature characteristics, dimethyl carbonate (DMC) is preferred.

Examples of the acyclic fluorocarbonate include acyclic fluorocarbonates represented by the following formula (Id-1):

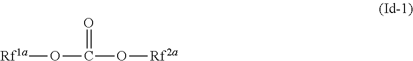

(wherein Rf^{1a} is a fluoroalkyl group having a portion represented by the formula:

(HCX^{1a}X^{2a}

(wherein X^{1a} and X^{2a} may be the same as or different from each other, and are each a hydrogen atom or a fluorine atom) at an end thereof and preferably having a fluorine content of 10 to 76 mass %, or an alkyl group, preferably a C1-C3 alkyl group; and Rf^{2a} is a fluoroalkyl group having a portion represented by the above formula or CF₃ at an end thereof and preferably having a fluorine content of 10 to 76 mass %);

acyclic fluorocarbonates represented by the following formula (Id-2):

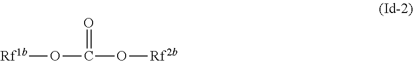

(wherein Rf^{1b} is a fluoroalkyl group having —CF₃ at an end thereof, having a fluorine content of 10 to 76 mass %, and having an ether bond; and Rf^{2b} is a fluoroalkyl group having an ether bond or a fluoroalkyl group, each having a fluorine content of 10 to 76 mass %); and

acyclic fluorocarbonates represented by the following formula (Id-3):

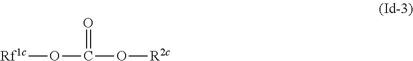

(wherein Rf^{1c} is a fluoroalkyl group having a portion represented by the formula:

HCFX^{1c}—

(wherein X^{1c} is a hydrogen atom or a fluorine atom) at an end thereof, having a fluorine content of 10 to 76 mass %, and having an ether bond; and R^{2c} is an alkyl group which may optionally have a hetero atom in the chain, with the hydrogen atom(s) thereof optionally being replaced by a halogen atom(s)).

Specific examples of the acyclic fluorocarbonate to be used include acyclic carbonates combined with a fluoro group, represented by the following formula (Id-4):

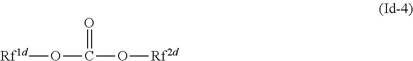

wherein Rf^{1d} and Rf^{2d} are each H(CF₂)₂CH₂—, FCH₂CF₂CH₂—, H(CF₂)₂CH₂CH₂—, CF₃CF₂CH₂—, CF₃CH₂CH₂—, CF₃CF(CF₃)CH₂CH₂—, C₃F₇OCF(CF₃)CH₂—, CF₃OCF(CF₃)CH₂—, CF₃OCF₂—, or the like.

For a good effect of reducing the internal resistance and maintenance of the low-temperature characteristics, the acyclic fluorocarbonate is preferably any of the following.

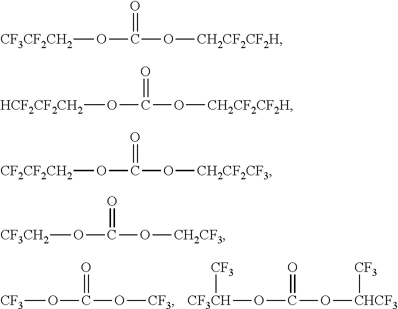

The acyclic fluorocarbonate may also be any of the following.

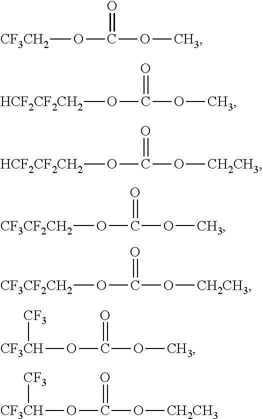

Examples of a solvent to be blended other than the cyclic carbonate (Ic) and the acyclic carbonate (Id) include non-fluorolactones and fluorolactones such as those represented by the formulas:

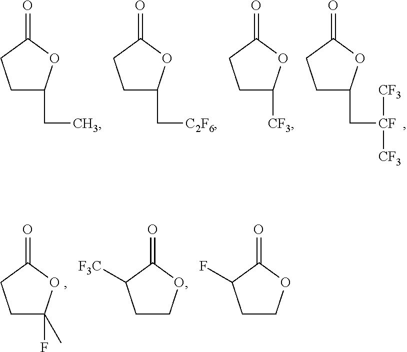

and furans and oxolanes.

The first and second electrolyte solutions of the present invention each may further include any other electrolyte salt in addition to the spirobipyrrolidinium salt.

Such an electrolyte salt may be a lithium salt. Preferred examples of the lithium salt include LiPF₆, LiBF₄, LiAsF₆, LiSbF₆, and LiN(SO₂C₂H₅)₂.

In order to further increase the capacity, a magnesium salt may be used. Preferred examples of the magnesium salt include Mg(ClO₄)₂ and Mg(OOC₂H₅)₂.

The first and second electrolyte solutions of the present invention each may further include any other quaternary ammonium salt in addition to the spirobipyrrolidinium salt. Such a quaternary ammonium salt may be preferably at least one selected from the group consisting of tetraalkyl quaternary ammonium salts, spirobipyridinium salts, imidazolium salts, N-alkylpyridinium salts, and N,N-dialkylpyrrolidinium salts.

Preferred examples of the tetraalkyl quaternary ammonium salts include tetraalkyl quaternary ammonium salts represented by the formula (IIA):

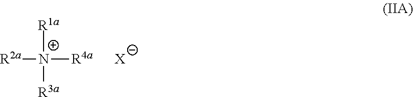

wherein R^{1a}, R^{2a}, R^{3a}, and R^{4a} may be the same as or different from each other, and are each a C1-C6 alkyl group which may optionally have an ether bond; and X⁻ is an anion). In order to improve the oxidation resistance, part or all of the hydrogen atoms of these ammonium salts may preferably be replaced by a fluorine atom(s) and/or a C1-C4 fluoroalkyl group(s).

Specific examples thereof include tetraalkyl quaternary ammonium salts represented by the formula (IIA-1):

(R^{1a})ₓ(R^{2a})_{y}N^{⊕}X^{⊖} (IIA-1)

(wherein R^{1a}, R^{2a}, and X⁻ are defined in the same manner as in the formula (IIA); x and y may be the same as or different from each other, and are each an integer of 0 to 4, and x+y=4); and

alkyl ether group-containing trialkyl ammonium salts represented by the formula (IIA-2):

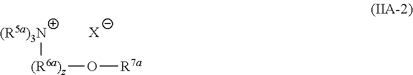

(wherein R^{5a} is a C1-C6 alkyl group; R⁶ is a C1-C6 divalent hydrocarbon group; R^{7a} is a C1-C4 alkyl group; z is 1 or 2; and X⁻ is an anion). Introduction of an alkyl ether group leads to a decrease in the viscosity.

The anion X⁻ may be an inorganic anion or may be an organic anion. Examples of the inorganic anion include AlCl₄⁻, BF₄⁻, PF₆⁻, AsF₆⁻, TaF₆⁻, I⁻, and SbF₆⁻. Examples of the organic anion include CF₃COO⁻, CF₃SO₃⁻, (CF₃SO₂)₂N⁻, and (C₂F₅SO₂)₂N⁻.

In order to achieve good oxidation resistance and ionic dissociation, BF₄⁻, PF₆⁻, AsF₆⁻, and SbF₆⁻ are preferred.

Preferred specific examples of the tetraalkyl quaternary ammonium salt include Et₄NBF₄, Et₄NClO₄, Et₄NPF₆, Et₄NAsF₆, Et₄NSbF₆, Et₄NCF₃SO₃, Et₄N(CF₃SO₂)₂N, Et₄NC₄F₉SO₃, Et₃MeNBF₄, Et₃MeNClO₄, Et₃MeNPF₆, Et₃MeNAsF₆, Et₃MeNSbF₆, Et₃MeNCF₃SO₃, Et₃MeN(CF₃SO₂)₂N, Et₃MeNC₄F₉SO₃, and N, N-diethyl-N-methyl-N-(2-methoxyethyl)ammonium salts. Particularly preferred examples thereof include Et₄NBF₄, Et₄NPF₆, Et₄NSbF₆, Et₄NAsF₆, Et₃MeNBF₄, and N,N-diethyl-N-methyl-N-(2-methoxyethyl)ammonium salts.

Preferred examples of the spirobipyridinium salt include those represented by the formula (IIB):

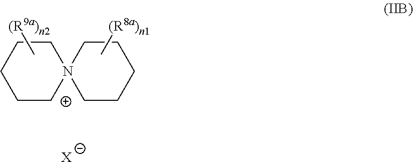

(wherein R^{8a} and R^{9a} may be the same as or different from each other, and are each a C1-C4 alkyl group; X⁻ is an anion; n1 is an integer of 0 to 5; and n2 is an integer of 0 to 5). In order to improve the oxidation resistance, part or all of the hydrogen atoms in the spirobipyridinium salt is also preferably replaced by a fluorine atom(s) and/or a C1-C4 fluoroalkyl group(s).

Preferred specific examples of the anion X⁻ are the same as those mentioned for the salts (IIA).

For example, one represented by the following formula:

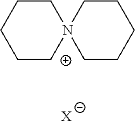

may be mentioned as a preferred specific example.

This spirobipyridinium salt is excellent in solubility, oxidation resistance, and ion conductivity.

Preferred examples of the imidazolium salt include those represented by the formula (IIC):

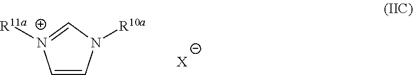

(wherein R^{10a} and R^{11a} may be the same as or different from each other, and are each a C1-C6 alkyl group; and X⁻ is an anion). In order to improve the oxidation resistance, part or all of the hydrogen atoms in the imidazolium salt is also preferably replaced by a fluorine atom(s) and/or a C1-C4 fluoroalkyl group(s).

Preferred specific examples of the anion X⁻ are the same as those mentioned for the salts (IIA).

For example, one represented by the following formula:

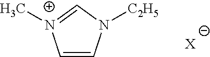

may be mentioned as a preferred specific example.

This imidazolium salt is excellent in that it has low viscosity and good solubility.

Preferred examples of the N-alkylpyridinium salt include those represented by the formula (IID):

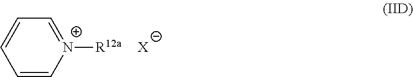

(wherein R^{12a} is a C1-C6 alkyl group; and X⁻ is an anion). In order to improve the oxidation resistance, part or all of the hydrogen atoms in the N-alkylpyridinium salt is also preferably replaced by a fluorine atom(s) and/or a C1-C4 fluoroalkyl group(s).

Preferred specific examples of the anion X⁻ are the same as those mentioned for the salts (IIA).

For example, those represented by the following formulas:

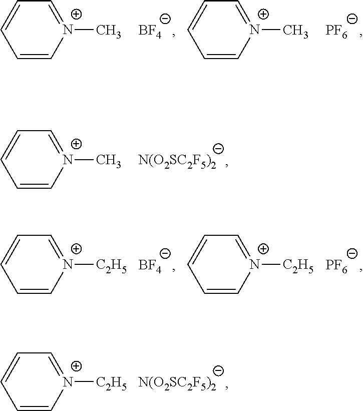

may be mentioned as preferred specific examples.

These N-alkylpyridinium salts are excellent in that they have low viscosity and good solubility.

Preferred examples of the N,N-dialkylpyrrolidinium salt include those represented by the formula (IIE):

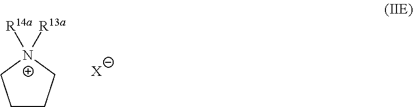

(wherein R^{13a} and R^{14a} may be the same as or different from each other, and are each a C1-C6 alkyl group; and X⁻ is an anion). In order to improve the oxidation resistance, part or all of the hydrogen atoms in the N,N-dialkylpyrrolidinium salt is also preferably replaced by a fluorine atom(s) and/or a C1-C4 fluoroalkyl group(s).

Preferred specific examples of the anion X⁻ are the same as those mentioned for the salts (IIA).

For example, those represented by the following formulas:

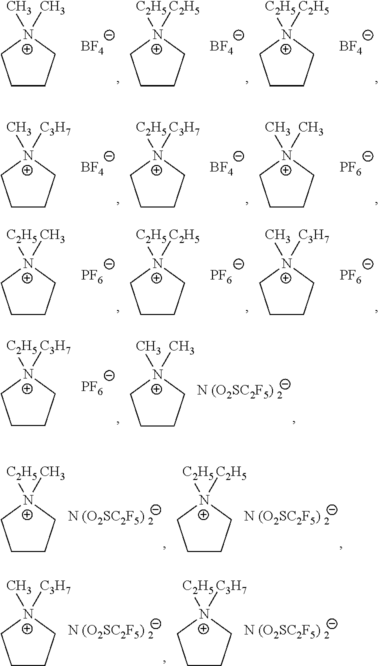

may be mentioned as preferred specific examples.

These N,N-dialkylpyrrolidinium salts are excellent in that they have low viscosity and good solubility.

For good solubility, oxidation resistance, and ion conductivity, particularly preferred among these ammonium salts are those represented by any of the formulas:

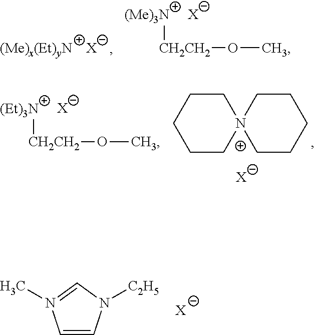

wherein Me is a methyl group; Et is an ethyl group; X⁻, x, and y are defined in the same manner as in the formula (IIA-1).

The first and second electrolyte solutions of the present invention each can be prepared by dissolving the spirobipyrrolidinium salt in the mononitrile compound.

The first and second electrolyte solutions of the present invention each may be a gel-like (plasticized) gel electrolyte solution combined with a polymer material that is soluble in or swellable in the mononitrile compound.

Examples of such a polymer material include conventionally known polyethylene oxide and polypropylene oxide, modified products thereof (see JP H08-222270 A, JP 2002-100405 A); polyacrylate polymers, polyacrylonitrile, and fluororesins such as polyvinylidene fluoride and vinylidene fluoride/hexafluoropropylene copolymers (see JP H04-506726 T, JP H08-507407 T, JP H10-294131 A); complexes of any of these fluororesins and any hydrocarbon resin (see JP H11-35765 A, JP H11-86630 A). In particular, polyvinylidene fluoride or a vinylidene fluoride/hexafluoropropylene copolymer is preferably used as a polymer material for the gel electrolyte.

In addition, ion conductive compounds disclosed in JP 2006-114401 A may also be used.

This ion conductive compound is an amorphous fluoropolyether compound having a fluoro group at a side chain and is represented by the formula (1-1):

P-(D)-Q (1-1)

wherein D is represented the formula (2-1):

-(D1)ₙ-(FAE)ₘ(AE)ₚ-(Y)_{q}— (2-1)

(wherein D1 is an ether unit that has a fluoroorganic group having an ether bond in a side chain and that is represented by the formula (2a):

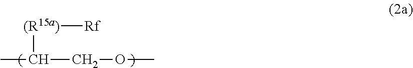

(wherein Rf is a fluoroorganic group which has an ether bond and which may optionally have a cross-linkable functional group; and R^{15a} is a group or a bond that links Rf and the main chain);

FAE is an ether unit that has a fluoroalkyl group in a side chain and that is represented by the formula (2b):

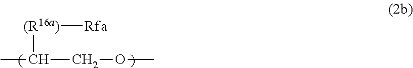

(wherein Rfa is a hydrogen atom or a fluoroalkyl group which may optionally have a cross-linkable functional group; and R^{16a} is a group or a bond that links Rfa and the main chain);

AE is an ether unit represented by the formula (2c):

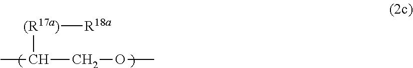

(wherein R^{18a} is a hydrogen atom, an alkyl group which may optionally have a cross-linkable functional group, an aliphatic cyclic hydrocarbon group which may optionally have a cross-linkable functional group, or an aromatic hydrocarbon group which may optionally have a cross-linkable functional group; and R^{17a} is a group or a bond that links R^{18a} and the main chain);

Y is a unit having at least one selected from the portions represented by the following formulas (2d-1) to (2d-3):

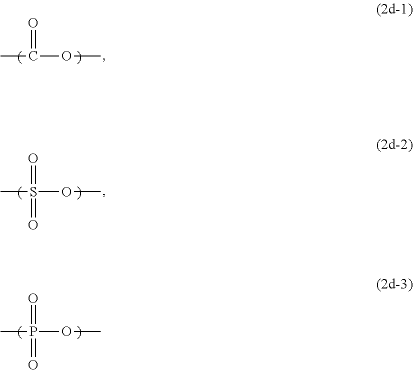

n is an integer of 0 to 200; m is an integer of 0 to 200; p is an integer of 0 to 10000; q is an integer of 1 to 100; n+m is not 0; and the bonding order of D1, FAE, AE, and Y is not specified); and

P and Q may be the same as or different from each other, and are each a hydrogen atom, an alkyl group which may optionally have a fluorine atom and/or a cross-linkable functional group, a phenyl group which may optionally have a fluorine atom and/or a cross-linkable functional group, a —COOH group, —OR^{19a} (where R^{19a} is a hydrogen atom or an alkyl group which may optionally have a fluorine atom and/or a cross-linkable functional group), an ester group, or a carbonate group (if an end of D is an oxygen atom, P and Q each are none of a —COOH group, —OR^{19a}, an ester group, and a carbonate group).

The first and second electrolyte solutions of the present invention each may further include any other additive, if necessary. Examples of such an additive include metal oxides and glass. Any of these additives may be added to the extent that the effects of the present invention are not impaired.

Preferably, the first and second electrolyte solutions of the present invention neither freeze nor cause coagulation of the electrolyte salt even at low temperature (e.g., 0° C. or −20° C.). Specifically, the viscosity at 0° C. is preferably 100 mPa·s or lower, more preferably 30 mPa·s or lower, particularly preferably 15 mPa·s or lower. Also specifically, the viscosity at −20° C. is preferably 100 mPa·s or lower, more preferably 40 mPa·s or lower, particularly preferably 15 mPa·s or lower.

The first and second electrolyte solutions of the present invention are preferably non-aqueous electrolytes.

The first and second electrolyte solutions of the present invention are useful as electrolyte solutions for electrochemical devices provided with various electrolyte solutions. Examples of the electrochemical devices include electric double-layer capacitors, lithium secondary batteries, radical batteries, solar cells (in particular, dye-sensitized solar cells), fuel cells, various electrochemical sensors, electrochromic elements, electrochemical switching elements, aluminum electrolytic capacitors, and tantalum electrolytic capacitors. Preferred are electric double-layer capacitors and lithium secondary batteries, and particularly preferred are electric double-layer capacitors. In addition, the electrolyte solutions may also be used as ion conductors of antistatic coating materials, for example.

As mentioned above, the first and second electrolyte solutions of the present invention are preferably to be used in electrochemical devices, particularly preferably to be used in electric double-layer capacitors.

An electrochemical device including the first or second electrolyte solution of the present invention, a positive electrode, and a negative electrode is also one aspect of the present invention. Examples of the electrochemical device include those mentioned above, and the electrochemical device is preferably an electric double-layer capacitor.

The following will specifically describe the configuration in the case where the electrochemical device of the present invention is an electric double-layer capacitor.

In the electric double-layer capacitor of the present invention, at least one of the positive electrode and the negative electrode is preferably a polarizable electrode. Examples of the polarizable electrode and a non-polarizable electrode include the following electrodes specifically disclosed in JP H09-7896 A.

The above polarizable electrode may be a polarizable electrode mainly containing activated carbon, and is preferably a polarizable electrode containing inactivated carbon that has a large specific surface area and a conductive material, such as carbon black, that provides electronic conductivity. The polarizable electrode can be formed by any of various methods. For example, a polarizable electrode comprising activated carbon and carbon black can be produced by mixing activated carbon powder, carbon black, and phenolic resin, press-molding the mixture, and then sintering and activating the mixture in an inert gas atmosphere and water vapor atmosphere. Preferably, this polarizable electrode is bonded to a current collector using a conductive adhesive, for example.

Alternatively, a polarizable electrode can also be formed by kneading activated carbon powder, carbon black, and a binder in the presence of alcohol and molding the mixture into a sheet shape, and then drying the sheet. This binder may be polytetrafluoroethylene, for example. Alternatively, a polarizable electrode integrated with a current collector can be produced by mixing activated carbon powder, carbon black, a binder, and a solvent to form slurry, and applying this slurry to metal foil of a current collector, and then drying the slurry.

Such a polarizable electrode mainly containing activated carbon may be used for the both electrodes of the electric double-layer capacitor. Still, the electric double-layer capacitor may have a structure in which one of the electrodes is a non-polarizable electrode, such as a combined structure of a positive electrode mainly containing a cell active material (e.g., metal oxide) and a negative electrode that is a polarizable electrode mainly containing activated carbon; or a combined structure of a negative electrode formed of lithium metal or lithium alloy and a polarizable electrode mainly containing activated carbon.

In place of or in combination with the activated carbon, any carbonaceous material such as carbon black, graphite, expanded graphite, porous carbon, carbon nanotube, carbon nanohorn, and Ketjenblack may be used.

The solvent used in preparation of slurry in the production of electrodes is preferably a solvent that dissolves a binder. In accordance with the type of binder, N-methylpyrrolidone, dimethyl formamide, toluene, xylene, isophorone, methyl ethyl ketone, ethyl acetate, methyl acetate, dimethyl phthalate, ethanol, methanol, butanol, or water is appropriately selected.

Examples of the activated carbon used for the polarizable electrode include phenolic resin-based activated carbon, coconut shell-based activated carbon, and petroleum coke-based activated carbon. In order to achieve a large capacity, petroleum coke-based activated carbon or phenolic resin-based activated carbon is preferably used. Examples of methods of activating the activated carbon include steam activation and molten KOH activation. In order to achieve a larger capacity, activated carbon prepared by molten KOH activation is preferably used.

Preferred examples of the conductive material used for the polarizable electrode include carbon black, Ketjenblack, acetylene black, natural graphite, artificial graphite, metal fiber, conductive titanium oxide, and ruthenium oxide. In order to achieve good conductivity (i.e., low internal resistance), and because too large an amount thereof may lead to a decreased capacity of the product, the amount of the conductive material such as carbon black used for the polarizable electrode is preferably 1 to 50 mass % in the sum of the amounts of the activated carbon and the conductive material.

In order to provide an electric double-layer capacitor having a large capacity and a low internal resistance, the activated carbon used for the polarizable electrode preferably has an average particle size of 20 μm or smaller and a specific surface area of 1500 to 3000 m²/g.

The current collector may be any chemically and electrochemically corrosion-resistant current collector. Preferred examples of the current collector used for the polarizable electrode mainly containing activated carbon include stainless steel, aluminum, titanium, and tantalum. A particularly preferred material in terms of the characteristics and price of the resulting electric double-layer capacitor is stainless steel or aluminum.

Examples of known electric double-layer capacitors include wound electric double-layer capacitors, laminated electric double-layer capacitors, and coin-type electric double-layer capacitors. The electric double-layer capacitor of the present invention may also be any of these types.

For example, a wound electric double-layer capacitor is assembled by winding a positive electrode and a negative electrode each of which includes a laminate (electrode) of a current collector and an electrode layer, and a separator in between to provide a wound element, putting this wound element in a case made of, for example, aluminum, filling the case with an electrolyte solution, and sealing the case with a rubber sealant.

In the present invention, a separator formed from a conventionally known material and having a conventionally known structure can also be used. Examples thereof include polyethylene porous membranes, and nonwoven fabric of polypropylene fiber, glass fiber, or cellulose fiber.

In accordance with any known method, the capacitor may be formed into a laminated electric double-layer capacitor in which a sheet-like positive electrode and negative electrode are stacked with an electrolyte solution and a separator in between or a coin-type electric double-layer capacitor in which a positive electrode and a negative electrode are fixed by a gasket with an electrolyte solution and a separator in between.

In the case where the electrochemical device of the present invention is not an electric double-layer capacitor, such an electrochemical device may have any configuration as long as the electrolyte solution is one of the first and second electrolyte solutions of the present invention, and may have a conventionally known configuration, for example.

### EXAMPLES

The present invention will be described hereinbelow referring to, but not limited to, examples and comparative examples.

### Examples 1 to 6 and Comparative Examples 1 to 7

### Production of Electrode

In each of Examples 1 to 5 and Comparative Examples 1 to 6, 100 parts by weight of steam-activated coconut shell activated carbon (YP50F, Kuraray Chemical Co., Ltd.), 3 parts by weight of acetylene black (Denka Black, Denka Co., Ltd.) serving as a conducting agent, 2 parts by weight of Ketjenblack (carbon ECP600JD, Lion Corp.), 4 parts by weight of an elastomer binder, 2 parts by weight of PTFE (Polyflon PTFE D-210C, Daikin Industries, Ltd.), and a surfactant (trade name: DN-800H, Daicel Chemical Industries, Ltd.) were mixed to provide a slurry for electrodes.

Edged aluminum (20CB, Japan Capacitor Industrial Co., Ltd.) was prepared as a current collector. The slurry for electrodes was applied to one surface of this current collector using a coating device to form an electrode layer (thickness: 100 μm). Thereby, an electrode was produced. In Example 6 and Comparative Example 7, electrodes were prepared in the same manner as in Example 1 except that YP80F (Kuraray Chemical Co., Ltd.) was used as the coconut shell activated carbon.

### (Preparation of Electrolyte Solution)

Spirobipyrrolidinium tetrafluoroborate (SBPBF₄) or spirobipyridinium hexafluorophosphate (SBPPF₆) was added to acetonitrile so as to have a predetermined concentration. Thereby, an electrolyte solution was prepared. The concentration of the spirobipyrrolidinium tetrafluoroborate (SBPBF₄) was 0.7 M (Example 1), 0.8 M (Example 2, Example 6), or 0.9 M (Example 3), and the concentration of the spirobipyridinium hexafluorophosphate (SBPPF₆) was 0.8 M (Example 5). For the purpose of comparison, electrolyte solutions containing spirobipyrrolidinium tetrafluoroborate (SBPBF₄) at 1.0 M (Comparative Example 1, Comparative Example 7) or 0.6 M (Comparative Example 2), an electrolyte solution containing spirobipyridinium hexafluorophosphate (SBPPF₆) at 1.0 M (Comparative Example 6), and electrolyte solutions containing tetraethylammonium tetrafluoroborate (TEABF₄) at 1.0 M (Comparative Example 3) or 0.8 M (Comparative Example 4) in place of spirobipyrrolidinium tetrafluoroborate (SBPBF₄) or spirobipyridinium hexafluorophosphate (SBPPF₆) were prepared.

Further, spirobipyrrolidinium tetrafluoroborate (SBPBF₄) was added to propionitrile so as to have a predetermined concentration. Thereby, an electrolyte solution was prepared. The concentration of the spirobipyrrolidinium tetrafluoroborate (SBPBF₄) was 0.8 M (Example 4). For the purpose of comparison, an electrolyte solution containing spirobipyrrolidinium tetrafluoroborate (SBPBF₄) at 1.0 M (Comparative Example 5) was prepared.

### (Production of Laminate Cell Electric Double-Layer Capacitor)

The resulting electrode was cut into a predetermined size (20×72 mm), and an electrode lead-out line was welded to the aluminum face of the current collector. A separator (TF45-30, Nippon Kodoshi Corp.) was then sandwiched between the electrodes, and the workpiece was enclosed in a laminate pouch (product No.: D-EL40H, manufacturer: Dai Nippon Printing Co., Ltd.). The electrolyte solution was put and impregnated into the pouch in a dry chamber, and the pouch was sealed. Thereby, a laminate cell electric double-layer capacitor was produced.

### (Evaluation of Properties of Electric Double-Layer Capacitor)

The properties of the resulting electric double-layer capacitor were evaluated by the following methods.

(1) Initial Properties (Internal Resistance (mΩ), Capacitance (F))

The laminate cell electric double-layer capacitor was connected with an electron power supply, and the charging voltage was increased up to the rated voltage while the cell was charged at a constant current. As the charging voltage reached the rated voltage, the voltage was kept constant for 10 minutes. Then, after the charging current was confirmed to be sufficiently decreased and saturated, constant-current discharging was started. The cell voltage was measured in every 0.1 seconds. The internal resistance (mΩ) and capacitance (F) of the capacitor were measured in accordance with the measurement methods in RC2377 of Japan Electronics and Information Technology Industries Association (JEITA).

### (Measurement Conditions in RC2377 of JEITA)

Power supply voltage: 3.0 V

Discharging current: 40 mA

### (2) Long-Term Reliability (Internal Resistance Increasing Rate, Capacitance Retention Ratio)

The laminate cell electric double-layer capacitor was put into a temperature-constant tank at a temperature of 65° C., and a voltage of 3.0 V was applied thereto for 500 hours. Thereby, the internal resistance and the capacitance were measured. The internal resistance and the capacitance were measured at the following timings: 0 hours, 250 hours, and 500 hours. Based on the measured values, the internal resistance increasing rate and the capacitance retention ratio were calculated by the following formulas.

Internal resistance increasing rate=(internal resistance at each measurement timing)/((initial) internal resistance before start of evaluation)

Capacitance retention ratio (%)=(capacitance at each measurement timing)/((initial) capacitance before start of evaluation)×100

The results of measuring the internal resistances are tabulated in the following Table 1.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| SBPBF₄ | 0.7M | 0.8M | 0.9M | 1.0M | 0.6M | 0 | 0 |
| TEABF₄ | 0 | 0 | 0 | 0 | 0 | 1.0M | 0.8M |
| SBPPF₆ | 0 | 0 | 0 | 0 | 0 | 0 | 0 |
| Acetonitrile (vol %) | 100% | 100% | 100% | 100% | 100% | 100% | 100% |
| Propionitrile (vol %) | 0 | 0 | 0 | 0 | 0 | 0 | 0 |
| Activated carbon | YP50F | YP50F | YP50F | YP50F | YP50F | YP50F | YP50F |
| Initial properties | 127 | 125 | 122 | 122 | 181 | 128 | 132 |
| (Internal resistance (mΩ)) | | | | | | | |
| Internal resistance | | | | | | | |
| increasing rate | | | | | | | |
| 0 h | 1.0 | 1.0 | 1.0 | 1.0 | 1.0 | 1.0 | 1.0 |
| 250 h | 1.1 | 1.1 | 1.2 | 1.3 | 1.1 | 1.5 | 1.6 |
| 500 h | 1.2 | 1.2 | 1.3 | 1.4 | 1.2 | 2.1 | 2.5 |

| | | Comparative | | Comparative | | Comparative |
|---|---|---|---|---|---|---|
| | Example 4 | Example 5 | Example 5 | Example 6 | Example 6 | Example 7 |
| SBPBF₄ | 0.8M | 1.0M | 0 | 0 | 0.8M | 1.0M |
| TEABF₄ | 0 | 0 | 0 | 0 | 0 | 0 |
| SBPPF₆ | 0 | 0 | 0.8M | 1.0M | 0 | 0 |
| Acetonitrile (vol %) | 0 | 0 | 100% | 100% | 100% | 100% |
| Propionitrile (vol %) | 100% | 100% | 0 | 0 | 0 | 0 |
| Activated carbon | YP50F | YP50F | YP50F | YP50F | YP80F | YP80F |
| Initial properties | 127 | 123 | 127 | 123 | 125 | 122 |
| (Internal resistance (mΩ)) | | | | | | |
| Internal resistance | | | | | | |
| increasing rate | | | | | | |
| 0 h | 1.0 | 1.0 | 1.0 | 1.0 | 1.0 | 1.0 |
| 250 h | 1.1 | 1.4 | 1.1 | 1.6 | 1.0 | 1.2 |
| 500 h | 1.2 | 1.5 | 1.2 | 1.8 | 1.1 | 1.3 |

The results of measuring the capacitance retention ratios are tabulated in the following Table 2.

TABLE 2

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| SBPBF₄ | 0.7M | 0.8M | 0.9M | 1.0M | 0.6M | 0 | 0 |
| TEABF₄ | 0 | 0 | 0 | 0 | 0 | 1.0M | 0.8M |
| SBPPF₆ | 0 | 0 | 0 | 0 | 0 | 0 | 0 |
| Acetonitrile (vol %) | 100% | 100% | 100% | 100% | 100% | 100% | 100% |
| Propionitrile (vol %) | 0 | 0 | 0 | 0 | 0 | 0 | 0 |
| Activated carbon | YP50F | YP50F | YP50F | YP50F | YP50F | YP50F | YP50F |
| Initial properties | 3.6 | 3.6 | 3.7 | 3.7 | 3.6 | 3.5 | 3.4 |
| (Capacitance (F)) | | | | | | | |
| Capacitance retention | | | | | | | |
| ratio (%) | | | | | | | |
| 0 h | 100 | 100 | 100 | 100 | 100 | 100 | 100 |
| 250 h | 94 | 93 | 93 | 91 | 95 | 83 | 80 |
| 500 h | 89 | 88 | 88 | 86 | 90 | 75 | 72 |

| | | Comparative | | Comparative | | Comparative |
|---|---|---|---|---|---|---|
| | Example 4 | Example 5 | Example 5 | Example 6 | Example 6 | Example 7 |
| SBPBF₄ | 0.8M | 1.0M | 0 | 0 | 0.8M | 1.0M |
| TEABF₄ | 0 | 0 | 0 | 0 | 0 | 0 |
| SBPPF₆ | 0 | 0 | 0.8M | 1.0M | 0 | 0 |
| Acetonitrile (vol %) | 0 | 0 | 100% | 100% | 100% | 100% |
| Propionitrile (vol %) | 100% | 100% | 0 | 0 | 0 | 0 |
| Activated carbon | YP50F | YP50F | YP50F | YP50F | YP80F | YP80F |
| Initial properties | 3.6 | 3.7 | 3.6 | 3.7 | 3.3 | 3.4 |
| (Capacitance (F)) | | | | | | |
| Capacitance retention | | | | | | |
| ratio (%) | | | | | | |
| 0 h | 100 | 100 | 100 | 100 | 100 | 100 |
| 250 h | 92 | 90 | 91 | 89 | 94 | 92 |
| 500 h | 87 | 85 | 86 | 84 | 89 | 87 |

### Examples 7 to 11, Comparative Examples 8 and 9

### Preparation of Electrolyte Solution

Acetonitrile and sulfolane were mixed in a volume ratio of 95/5, and spirobipyrrolidinium tetrafluoroborate (SBPBF₄) was added to the resulting liquid mixture so as to have a predetermined concentration. Thereby, an electrolyte solution was prepared. The concentration of the spirobipyrrolidinium tetrafluoroborate (SBPBF₄) was 0.7 M (Example 7), 0.8 M (Example 8), 0.9 M (Example 9), 1.0 M (Example 10), or 1.3 M (Example 11). For the purpose of comparison, electrolyte solutions containing spirobipyrrolidinium tetrafluoroborate (SBPBF₄) at 0.6 M (Comparative Example 8) or 1.4 M (Comparative Example 9) were prepared.

### (Production of Electric Double-Layer Capacitor, and Evaluation of Properties Thereof)

An electric double-layer capacitor was produced in the same manner as in Example 1 using the electrolyte solution obtained above. The initial properties (internal resistance (mΩ), capacitance (F)), internal resistance increasing rate, and capacitance retention ratio were measured and evaluated in the same manner as in Example 1.

The results of measuring the internal resistances are tabulated in the following Table 3.

TABLE 3

| | | | | | | Comparative | Comparative |
|---|---|---|---|---|---|---|---|
| | Example 7 | Example 8 | Example 9 | Example 10 | Example 11 | Example 8 | Example 9 |
| SBPBF₄ | 0.7M | 0.8M | 0.9M | 1.0M | 1.3M | 0.6M | 1.4M |
| Acetonitrile (vol %) | 95% | 95% | 95% | 95% | 95% | 95% | 95% |
| Sulfolane (vol %) | 5% | 5% | 5% | 5% | 5% | 5% | 5% |
| Initial properties | 128 | 126 | 123 | 123 | 121 | 185 | 120 |
| (Internal resistance (mΩ)) | | | | | | | |
| Internal resistance | | | | | | | |
| increasing rate | | | | | | | |
| 0 h | 1.0 | 1.0 | 1.0 | 1.0 | 1.0 | 1.0 | 1.0 |
| 250 h | 1.0 | 1.0 | 1.1 | 1.1 | 1.3 | 1.1 | 1.4 |
| 500 h | 1.1 | 1.1 | 1.1 | 1.2 | 1.8 | 1.1 | 2.1 |

The results of measuring the capacitance retention ratios are tabulated in the following Table 4.

TABLE 4

| | | | | | | Comparative | Comparative |
|---|---|---|---|---|---|---|---|
| | Example 7 | Example 8 | Example 9 | Example 10 | Example 11 | Example 8 | Example 9 |
| SBPBF₄ | 0.7M | 0.8M | 0.9M | 1.0M | 1.3M | 0.6M | 1.4M |
| Acetonitrile (vol %) | 95% | 95% | 95% | 95% | 95% | 95% | 95% |
| Sulfolane (vol %) | 5% | 5% | 5% | 5% | 5% | 5% | 5% |
| Initial properties | 3.6 | 3.6 | 3.7 | 3.7 | 3.8 | 3.6 | 3.8 |
| (Capacitance (F)) | | | | | | | |
| Capacitance retention ratio (%) | | | | | | | |
| 0 h | 100 | 100 | 100 | 100 | 100 | 100 | 100 |
| 250 h | 95 | 94 | 94 | 92 | 86 | 96 | 84 |
| 500 h | 90 | 89 | 89 | 87 | 81 | 91 | 79 |

### Examples 12 to 16, Comparative Example 10

### Preparation of Electrolyte Solution

Acetonitrile and 3-methyl sulfolane were mixed in a volume ratio of 95/5, and spirobipyrrolidinium tetrafluoroborate (SBPBF₄) was added to the resulting liquid mixture so as to have a predetermined concentration. Thereby, an electrolyte solution was prepared. The concentration of the spirobipyrrolidinium tetrafluoroborate (SBPBF₄) was 0.7 M (Example 12), 0.8 M (Example 13), 0.9 M (Example 14), 1.0 M (Example 15), or 1.3 M (Example 16). For the purpose of comparison, an electrolyte solution containing spirobipyrrolidinium tetrafluoroborate (SBPBF₄) at a concentration of 0.6 M (Comparative Example 10) was prepared.

### (Production of Electric Double-Layer Capacitor, and Evaluation of Properties Thereof)

An electric double-layer capacitor was produced in the same manner as in Example 1 using the electrolyte solution obtained above. The initial properties (internal resistance (mΩ), capacitance (F)), internal resistance increasing rate, and capacitance retention ratio were measured and evaluated in the same manner as in Example 1.

The results of measuring the internal resistances are tabulated in the following Table 5.

TABLE 5

| | | | | | | Comparative |
|---|---|---|---|---|---|---|
| | Example 12 | Example 13 | Example 14 | Example 15 | Example 16 | Example 10 |
| SBPBF₄ | 0.7M | 0.8M | 0.9M | 1.0M | 1.3M | 0.6M |
| Acetonitrile (vol %) | 95% | 95% | 95% | 95% | 95% | 95% |
| 3-Methylsulfolane (vol %) | 5% | 5% | 5% | 5% | 5% | 5% |
| Initial properties | 128 | 126 | 123 | 123 | 121 | 186 |
| (Internal resistance (mΩ)) | | | | | | |
| Internal resistance | | | | | | |
| increasing rate | | | | | | |
| 0 h | 1.0 | 1.0 | 1.0 | 1.0 | 1.0 | 1.0 |
| 250 h | 1.1 | 1.1 | 1.1 | 1.1 | 1.2 | 1.1 |
| 500 h | 1.1 | 1.1 | 1.1 | 1.1 | 1.3 | 1.1 |

The results of measuring the capacitance retention ratios are tabulated in the following Table 6.

TABLE 6

| | | | | | | Comparative |
|---|---|---|---|---|---|---|
| | Example 12 | Example 13 | Example 14 | Example 15 | Example 16 | Example 10 |
| SBPBF₄ | 0.7M | 0.8M | 0.9M | 1.0M | 1.3M | 0.6M |
| Acetonitrile (vol %) | 95% | 95% | 95% | 95% | 95% | 95% |
| 3-Methylsulfolane (vol %) | 5% | 5% | 5% | 5% | 5% | 5% |
| Initial properties | 3.6 | 3.6 | 3.7 | 3.7 | 3.8 | 3.6 |
| (Capacitance (F)) | | | | | | |
| Capacitance retention | | | | | | |
| ratio (%) | | | | | | |
| 0 h | 100 | 100 | 100 | 100 | 100 | 100 |
| 250 h | 94 | 93 | 93 | 92 | 91 | 95 |
| 500 h | 89 | 88 | 88 | 87 | 87 | 90 |

### Comparative Examples 11 and 12

### Preparation of Electrolyte Solution

Acetonitrile and sulfolane were mixed in a volume ratio of 95/5, and tetraethylammonium tetrafluoroborate (TEABF₄) was added to the resulting liquid mixture so as to have a predetermined concentration. Thereby, an electrolyte solution was prepared. The concentration of the tetraethylammonium tetrafluoroborate (TEABF₄) was 0.7 M (Comparative Example 11) or 1.0 M (Comparative Example 12).

### (Production of Electric Double-Layer Capacitor, and Evaluation of Properties Thereof)

An electric double-layer capacitor was produced in the same manner as in Example 1 using the electrolyte solution obtained above. The initial properties (internal resistance (mΩ), capacitance (F)), internal resistance increasing rate, and capacitance retention ratio were measured and evaluated in the same manner as in Example 1.

The results of measuring the internal resistances are tabulated in the following Table 7.

TABLE 7

| | Comparative | Comparative |
|---|---|---|
| | Example 11 | Example 12 |
| TEABF₄ | 0.7M | 1.0M |
| Acetonitrile (vol %) | 95% | 95% |
| Sulfolane (vol %) | 5% | 5% |
| Initial properties | 132 | 128 |
| (Internal resistance | | |
| (mΩ)) | | |
| Internal resistance | | |
| increasing rate | | |
| 0 h | 1.0 | 1.0 |
| 250 h | 1.8 | 1.4 |
| 500 h | 2.1 | 1.8 |

The results of measuring the capacitance retention ratios are tabulated in the following Table 8.

TABLE 8

| | Comparative | Comparative |
|---|---|---|
| | Example 11 | Example 12 |
| TEABF₄ | 0.7M | 1.0M |
| Acetonitrile (vol %) | 95% | 95% |
| Sulfolane (vol %) | 5% | 5% |
| Initial properties | 3.4 | 3.5 |
| (Capacitance (F)) | | |
| Capacitance retention | | |
| ratio (%) | | |
| 0 h | 100 | 100 |
| 250 h | 80 | 86 |
| 500 h | 72 | 82 |

### Examples 17 to 24

### Preparation of Electrolyte Solution

Acetonitrile and sulfolane were mixed in a volume ratio of 95/5. Adiponitrile was added to the resulting liquid mixture so as to have a predetermined concentration, and spirobipyrrolidinium tetrafluoroborate (SBPBF₄) was further added thereto so as to have a concentration of 0.8 M. Thereby, an electrolyte solution was prepared. The concentration of the adiponitrile was 0.05 mass % (Example 17), 0.5 mass % (Example 18), 1.0 mass % (Example 19), or 5.0 mass % (Example 20). Also, electrolyte solutions of adiponitrile at 0.05 mass % (Example 21), 0.5 mass % (Example 22), 1.0 mass % (Example 23), or 5.0 mass % (Example 24) were prepared in the same manner as in Examples 17 to 20 except that the concentration of the spirobipyrrolidinium tetrafluoroborate (SBPBF₄) was adjusted to 0.9 M.

### (Production of Electric Double-Layer Capacitor, and Evaluation of Properties Thereof)

An electric double-layer capacitor was produced in the same manner as in Example 1 using the electrolyte solution obtained above. For the resulting electric double-layer capacitor, the initial properties (internal resistance (mΩ), capacitance (F)), internal resistance increasing rate, and capacitance retention ratio were measured and evaluated in the same manner as in Example 1.

The results of measuring the internal resistances are tabulated in the following Table 9.

TABLE 9

| | Example 17 | Example 18 | Example 19 | Example 20 | Example 21 | Example 22 | Example 23 | Example 24 |
|---|---|---|---|---|---|---|---|---|
| SBPBF₄ | 0.8M | 0.8M | 0.8M | 0.8M | 0.9M | 0.9M | 0.9M | 0.9M |
| Acetonitrile (vol %) | 95% | 95% | 95% | 95% | 95% | 95% | 95% | 95% |
| Sulfolane (vol %) | 5% | 5% | 5% | 5% | 5% | 5% | 5% | 5% |
| Adiponitrile | 0.05 wt % | 0.5 wt % | 1.0 wt % | 5.0 wt % | 0.05 wt % | 0.5 wt % | 1.0 wt % | 5.0 wt % |
| Initial properties | 127 | 127 | 127 | 127 | 127 | 127 | 127 | 127 |
| (Internal resistance (mΩ)) | | | | | | | | |
| Internal resistance | | | | | | | | |
| increasing rate | | | | | | | | |
| 0 h | 1.0 | 1.0 | 1.0 | 1.0 | 1.0 | 1.0 | 1.0 | 1.0 |
| 250 h | 1.0 | 1.0 | 1.1 | 1.1 | 1.0 | 1.0 | 1.1 | 1.1 |
| 500 h | 1.1 | 1.1 | 1.1 | 1.1 | 1.1 | 1.1 | 1.1 | 1.1 |

The results of measuring the capacitance retention ratios are tubulated in the follow Table 10.

TABLE 10

| | Example 17 | Example 18 | Example 19 | Example 20 | Example 21 | Example 22 | Example 23 | Example 24 |
|---|---|---|---|---|---|---|---|---|
| SBPBF₄ | 0.8M | 0.8M | 0.8M | 0.8M | 0.9M | 0.9M | 0.9M | 0.9M |
| Acetonitrile (vol %) | 95% | 95% | 95% | 95% | 95% | 95% | 95% | 95% |
| Sulfolane (vol %) | 5% | 5% | 5% | 5% | 5% | 5% | 5% | 5% |
| Adiponitrile | 0.05 wt % | 0.5 wt % | 1.0 wt % | 5.0 wt % | 0.05 wt % | 0.5 wt % | 1.0 wt % | 5.0 wt % |
| Initial properties | 3.6 | 3.6 | 3.6 | 3.6 | 3.7 | 3.7 | 3.7 | 3.7 |
| (Capacitance (F)) | | | | | | | | |
| Capacitance retention | | | | | | | | |
| ratio (%) | | | | | | | | |
| 0 h | 100 | 100 | 100 | 100 | 100 | 100 | 100 | 100 |
| 250 h | 96 | 96 | 95 | 95 | 96 | 96 | 95 | 95 |
| 500 h | 91 | 91 | 90 | 90 | 91 | 91 | 90 | 90 |

### Examples 25 to 32

### Preparation of Electrolyte Solution

Acetonitrile and sulfolane were mixed in a volume ratio of 95/5. A fluorine-containing acyclic sulfone (C₄H₅F₄O₃S) was added to the resulting liquid mixture so as to have a predetermined concentration, and spirobipyrrolidinium tetrafluoroborate (SBPBF₄) was further added thereto so as to have a concentration of 0.8 M. Thereby, an electrolyte solution was prepared. The concentration of the fluorine-containing acyclic sulfone was 0.05 mass % (Example 25), 0.5 mass % (Example 26), 1.0 mass % (Example 27), or 5.0 mass % (Example 28). Also, electrolyte solutions of a fluorine-containing acyclic sulfone at 0.05 mass % (Example 29), 0.5 mass % (Example 30), 1.0 mass % (Example 31), or 5.0 mass % (Example 32) were prepared in the same manner as in Examples 24 to 27 except that the concentration of the spirobipyrrolidinium tetrafluoroborate (SBPBF₄) was adjusted to 0.9 M.

### (Production of Electric Double-Layer Capacitor, and Evaluation of Properties Thereof)

An electric double-layer capacitor was produced in the same manner as in Example 1 using the electrolyte solution obtained above. For the resulting electric double-layer capacitor, the initial properties (internal resistance (mΩ), capacitance (F)), internal resistance increasing rate, and capacitance retention ratio were measured and evaluated in the same manner as in Example 1.

The results of measuring the internal resistances are tabulated in the following Table 11.

TABLE 11

| | Example 25 | Example 26 | Example 27 | Example 28 | Example 29 | Example 30 | Example 31 | Example 32 |
|---|---|---|---|---|---|---|---|---|
| SBPBF₄ | 0.8M | 0.8M | 0.8M | 0.8M | 0.9M | 0.9M | 0.9M | 0.9M |
| Acetonitrile (vol %) | 95% | 95% | 95% | 95% | 95% | 95% | 95% | 95% |
| Sulfolane (vol %) | 5% | 5% | 5% | 5% | 5% | 5% | 5% | 5% |
| Fluorine-containing | 0.05 wt % | 0.5 wt % | 1.0 wt % | 5.0 wt % | 0.05 wt % | 0.5 wt % | 1.0 wt % | 5.0 wt % |
| acyclic sulfone | | | | | | | | |
| Initial properties | 127 | 127 | 127 | 127 | 127 | 127 | 127 | 127 |
| (Internal resistance (mΩ)) | | | | | | | | |
| Internal resistance | | | | | | | | |
| increasing rate | | | | | | | | |
| 0 h | 1.0 | 1.0 | 1.0 | 1.0 | 1.0 | 1.0 | 1.0 | 1.0 |
| 250 h | 1.0 | 1.0 | 1.1 | 1.1 | 1.0 | 1.0 | 1.1 | 1.1 |
| 500 h | 1.1 | 1.1 | 1.1 | 1.1 | 1.1 | 1.1 | 1.1 | 1.1 |

The results of measuring the capacitance retention ratios are tabulated in the following Table 12.

TABLE 12

| | Example 25 | Example 26 | Example 27 | Example 28 | Example 29 | Example 30 | Example 31 | Example 32 |
|---|---|---|---|---|---|---|---|---|
| SBPBF₄ | 0.8M | 0.8M | 0.8M | 0.8M | 0.9M | 0.9M | 0.9M | 0.9M |
| Acetonitrile (vol %) | 95% | 95% | 95% | 95% | 95% | 95% | 95% | 95% |
| Sulfolane (vol %) | 5% | 5% | 5% | 5% | 5% | 5% | 5% | 5% |
| Fluorine-containing | 0.05 wt % | 0.5 wt % | 1.0 wt % | 5.0 wt % | 0.05 wt % | 0.5 wt % | 1.0 wt % | 5.0 wt % |
| acyclic sulfone | | | | | | | | |
| Initial properties | 3.6 | 3.6 | 3.6 | 3.6 | 3.7 | 3.7 | 3.7 | 3.7 |
| (Capacitance (F)) | | | | | | | | |
| Capacitance retention | | | | | | | | |
| ratio (%) | | | | | | | | |
| 0 h | 100 | 100 | 100 | 100 | 100 | 100 | 100 | 100 |
| 250 h | 96 | 96 | 95 | 95 | 95 | 95 | 95 | 95 |
| 500 h | 90 | 90 | 90 | 90 | 90 | 90 | 90 | 90 |

### Examples 33 to 36

### Preparation of Electrolyte Solution

Acetonitrile and sulfolane were mixed in a volume ratio of 95/5. Succinonitrile was added to the resulting liquid mixture so as to have a predetermined concentration, and spirobipyrrolidinium tetrafluoroborate (SBPBF₄) was further added thereto so as to have a concentration of 0.9 M. Thereby, an electrolyte solution was prepared. The concentration of the succinonitrile was 0.05 mass % (Example 33), 0.5 mass % (Example 34), 1.0 mass % (Example 35), or 5.0 mass % (Example 36).

### (Production of Electric Double-Layer Capacitor, and Evaluation of Properties Thereof)

An electric double-layer capacitor was produced in the same manner as in Example 1 using the electrolyte solution obtained above. For the resulting electric double-layer capacitor, the initial properties (internal resistance (mΩ), capacitance (F)), internal resistance increasing rate, and capacitance retention ratio were measured and evaluated in the same manner as in Example 1.

The results of measuring the internal resistances are tabulated in the following Table 13.

TABLE 13

| | Example | Example | Example | Example |
|---|---|---|---|---|
| | 33 | 34 | 35 | 36 |
| SBPBF₄ | 0.9M | 0.9M | 0.9M | 0.9M |
| Acetonitrile (vol %) | 95% | 95% | 95% | 95% |
| Sulfolane (vol %) | 5% | 5% | 5% | 5% |
| Succinonitrile | 0.05 wt % | 0.5 wt % | 1.0 wt % | 5.0 wt % |
| Initial properties | 127 | 127 | 127 | 127 |
| (Internal resistance | | | | |
| (mΩ)) | | | | |
| Internal resistance | | | | |
| increasing rate | | | | |
| 0 h | 1.0 | 1.0 | 1.0 | 1.0 |
| 250 h | 1.0 | 1.0 | 1.1 | 1.1 |
| 500 h | 1.1 | 1.1 | 1.1 | 1.1 |

The results of measuring the capacitance retention ratios are tabulated in the following Table 14.

TABLE 14

| | Example | Example | Example | Example |
|---|---|---|---|---|
| | 33 | 34 | 35 | 36 |
| SBPBF₄ | 0.9M | 0.9M | 0.9M | 0.9M |
| Acetonitrile (vol %) | 95% | 95% | 95% | 95% |
| Sulfolane (vol %) | 5% | 5% | 5% | 5% |
| Succinonitrile | 0.05 wt % | 0.5 wt % | 1.0 wt % | 5.0 wt % |
| Initial properties | 3.7 | 3.7 | 3.7 | 3.7 |
| (Capacitance (F)) | | | | |
| Capacitance retention | | | | |
| ratio (%) | | | | |
| 0 h | 100 | 100 | 100 | 100 |
| 250 h | 95 | 95 | 95 | 95 |
| 500 h | 90 | 90 | 90 | 90 |

### Examples 37 to 40

Acetonitrile and sulfolane were mixed in a volume ratio of 95/5. Glutaronitrile was added to the resulting liquid mixture so as to have a predetermined concentration, and spirobipyrrolidinium tetrafluoroborate (SBPBF₄) was further added thereto so as to have a concentration of 0.9 M. Thereby, an electrolyte solution was prepared. The concentration of the glutaronitrile was 0.05 mass % (Example 37), 0.5 mass % (Example 38), 1.0 mass % (Example 39), or 5.0 mass % (Example 40).

### (Production of Electric Double-Layer Capacitor, and Evaluation of Properties Thereof)

An electric double-layer capacitor was produced in the same manner as in Example 1 using the electrolyte solution obtained above. For the resulting electric double-layer capacitor, the initial properties (internal resistance (mΩ), capacitance (F)), internal resistance increasing rate, and capacitance retention ratio were measured and evaluated in the same manner as in Example 1.

The results of measuring the internal resistances are tabulated in the following Table 15.

TABLE 15

| | Example | Example | Example | Example |
|---|---|---|---|---|
| | 37 | 38 | 39 | 40 |
| SBPBF₄ | 0.9M | 0.9M | 0.9M | 0.9M |
| Acetonitrile (vol %) | 95% | 95% | 95% | 95% |
| Sulfolane (vol %) | 5% | 5% | 5% | 5% |
| Glutaronitrile | 0.05 wt % | 0.5 wt % | 1.0 wt % | 5.0 wt % |
| Initial properties | 128 | 128 | 128 | 128 |
| (Internal resistance | | | | |
| (mΩ)) | | | | |
| Internal resistance | | | | |
| increasing rate | | | | |
| 0 h | 1.0 | 1.0 | 1.0 | 1.0 |
| 250 h | 1.0 | 1.0 | 1.1 | 1.1 |
| 500 h | 1.1 | 1.1 | 1.1 | 1.1 |

The results of measuring the capacitance retention ratios are tabulated in the following Table 16.

TABLE 16

| | Example | Example | Example | Example |
|---|---|---|---|---|
| | 37 | 38 | 39 | 40 |
| SBPBF₄ | 0.9M | 0.9M | 0.9M | 0.9M |
| Acetonitrile (vol %) | 95% | 95% | 95% | 95% |
| Sulfolane (vol %) | 5% | 5% | 5% | 5% |
| Glutaronitrile | 0.05 wt % | 0.5 wt % | 1.0 wt % | 5.0 wt % |
| Initial properties | 3.7 | 3.7 | 3.7 | 3.7 |
| (Capacitance (F)) | | | | |
| Capacitance retention | | | | |
| ratio (%) | | | | |
| 0 h | 100 | 100 | 100 | 100 |
| 250 h | 95 | 95 | 96 | 96 |
| 500 h | 90 | 90 | 90 | 90 |

### Examples 41 to 44

### Preparation of Electrolyte Solution

Acetonitrile and sulfolane were mixed in a volume ratio of 95/5. A fluorine-containing acyclic sulfonic ester (1-propanol, 2,2,3,3-tetrafluoro-methanesulfonate) was added to the resulting liquid mixture so as to have a predetermined concentration, and spirobipyrrolidinium tetrafluoroborate (SBPBF₄) was further added thereto so as to have a concentration of 0.8 M. Thereby, an electrolyte solution was prepared. The concentration of the fluorine-containing acyclic sulfonic ester was 0.05 mass % (Example 41), 0.5 mass % (Example 42), 1.0 mass % (Example 43), or 5.0 mass % (Example 44).

### (Production of Electric Double-Layer Capacitor, and Evaluation of Properties Thereof)

An electric double-layer capacitor was produced in the same manner as in Example 1 using the electrolyte solution obtained above. For the resulting electric double-layer capacitor, the initial properties (internal resistance (mΩ), capacitance (F)), internal resistance increasing rate, and capacitance retention ratio were measured and evaluated in the same manner as in Example 1.

The results of measuring the internal resistances are tabulated in the following Table 17.

TABLE 17

| | Example | Example | Example | Example |
|---|---|---|---|---|
| | 41 | 42 | 43 | 44 |
| SBPBF₄ | 0.8M | 0.8M | 0.8M | 0.8M |
| Acetonitrile (vol %) | 95% | 95% | 95% | 95% |
| Sulfolane (vol %) | 5% | 5% | 5% | 5% |
| Fluorine-containing | 0.05 wt % | 0.5 wt % | 1.0 wt % | 5.0 wt % |
| acyclic sulfone | | | | |
| Initial properties | 127 | 127 | 127 | 127 |
| (Internal resistance | | | | |
| (mΩ)) | | | | |
| Internal resistance | | | | |
| increasing rate | | | | |
| 0 h | 1.0 | 1.0 | 1.0 | 1.0 |
| 250 h | 1.0 | 1.0 | 1.1 | 1.1 |
| 500 h | 1.1 | 1.1 | 1.1 | 1.1 |

The results of measuring the capacitance retention ratios are tabulated in the following Table 18.

TABLE 18

| | Example | Example | Example | Example |
|---|---|---|---|---|
| | 41 | 42 | 43 | 44 |
| SBPBF₄ | 0.8M | 0.8M | 0.8M | 0.8M |
| Acetonitrile (vol %) | 95% | 95% | 95% | 95% |
| Sulfolane (vol %) | 5% | 5% | 5% | 5% |
| Fluorine-containing | 0.05 wt % | 0.5 wt % | 1.0 wt % | 5.0 wt % |
| acyclic sulfone | | | | |
| Initial properties | 3.6 | 3.6 | 3.6 | 3.6 |
| (Capacitance (F)) | | | | |
| Capacitance retention | | | | |
| ratio (%) | | | | |
| 0 h | 100 | 100 | 100 | 100 |
| 250 h | 97 | 97 | 96 | 95 |
| 500 h | 91 | 91 | 91 | 90 |

1. An electrolyte solution comprising a mononitrile compound and a spirobipyrrolidinium salt, and being free from a non-fluorinated sulfolane compound,
the spirobipyrrolidinium salt being present at a concentration of not less than 0.70 mol/L but less than 1.00 mol/L.

2. An electrolyte solution comprising:
a mononitrile compound;
a non-fluorinated sulfolane compound; and
a spirobipyrrolidinium salt,
the spirobipyrrolidinium salt being present at a concentration of not less than 0.70 mol/L and not more than 1.30 mol/L.

3. The electrolyte solution according to claim 1,
wherein the spirobipyrrolidinium salt is spirobipyrrolidinium tetrafluoroborate.

4. The electrolyte solution according to claim 1,
wherein the mononitrile compound is acetonitrile.

5. The electrolyte solution according to claim 1, further comprising 0.05 to 5.0 mass % of a dinitrile compound.

6. The electrolyte solution according to claim 1, further comprising 0.05 to 5.0 mass % of a fluorine-containing acyclic sulfone or a fluorine-containing acyclic sulfonic ester.

7. The electrolyte solution according to claim 1, which is to be used for electrochemical devices.

8. The electrolyte solution according to claim 1, which is to be used for electric double-layer capacitors.

9. An electrochemical device comprising:
the electrolyte solution according to claim 1;
a positive electrode; and
a negative electrode.

10. The electrochemical device according to claim 9, which is an electric double-layer capacitor.

11. The electrolyte solution according to claim 2,
wherein the spirobipyrrolidinium salt is spirobipyrrolidinium tetrafluoroborate.

12. The electrolyte solution according to claim 2, wherein the mononitrile compound is acetonitrile.

13. The electrolyte solution according to claim 2, further comprising 0.05 to 5.0 mass % of a dinitrile compound.

14. The electrolyte solution according to claim 2, further comprising 0.05 to 5.0 mass % of a fluorine-containing acyclic sulfone or a fluorine-containing acyclic sulfonic ester.

15. The electrolyte solution according to claim 2, which is to be used for electrochemical devices.

16. The electrolyte solution according to claim 2, which is to be used for electric double-layer capacitors.

17. An electrochemical device comprising:
the electrolyte solution according to claim 2;
a positive electrode; and
a negative electrode.

18. The electrochemical device according to claim 17, which is an electric double-layer capacitor.
